(19) United States
(12) Patent Application Publication
(10) Pub. No.: US 2022/0375339 A1
(43) Pub. Date: Nov. 24, 2022

(54) METHOD FOR EXPRESSING CHARACTERISTICS OF TRAFFIC FLOW BASED ON QUANTUM HARMONIC OSCILLATOR MODEL

(71) Applicant: NANJING NORMAL UNIVERSITY, Jiangsu (CN)

(72) Inventors: Wen LUO, Jiangsu (CN); Zhaoyuan YU, Jiangsu (CN); Xu HU, Jiangsu (CN); Linwang YUAN, Jiangsu (CN); Zengjie WANG, Jiangsu (CN)

(73) Assignee: NANJING NORMAL UNIVERSITY, Jiangsu (CN)

(21) Appl. No.: 17/608,752

(22) PCT Filed: Nov. 20, 2020
(86) PCT No.: PCT/CN2020/130412

§ 371 Date: Nov. 3, 2021

(30) Foreign Application Priority Data
Nov. 19, 2020 (CN) 202011301003.0

(51) Int. Cl. G08G 1/01; G08G 1/052; G06F 17/13; G06F 17/18; G06N 10/20

(52) U.S. Cl. CPC G08G 1/0145; G08G 1/0125; G08G 1/052; G06F 17/13; G06F 17/18; G06N 10/20

(57) ABSTRACT

The present invention discloses a method for expressing traffic flow characteristics based on a quantum harmonic oscillator model, including: (1) constructing an energy eigenequation of a quantum harmonic oscillator (QHO) for vehicle movement, and converting the energy eigenequation to an Hermite polynomial; (2) solving traffic flow characteristic parameters using K-order Hermite polynomial approximation; and (3) expressing the traffic flow characteristic parameters on a sphere. On the premise of the autonomous decision of a driving strategy by a driver and centering on the objective limitation that the individual accurate state information in the long-distance expressway traffic flow is not observable, the dynamic evolution of the speed and the state of the vehicle is described using a quantum state, the driving state of the vehicle is expressed as the superposition state of three driving states, and the probability of the three states is represented using QHO model parameters.

### TECHNICAL FIELD

The present invention relates to the technical fields of quantum mechanics and traffic geography, and particularly to a method for expressing characteristics of a traffic flow based on a quantum harmonic oscillator model.

### BACKGROUND

Expressway, as a framework in an inter-city traffic network, plays an important role in good operation of inter-city traffic. In recent years, with the development of networks and transportation, the traffic volume of traveling by cars and freight transport by large cars on expressways is increasing day by day, and the expressway traffic flow obviously shows the characteristics of long duration, high speed, non-uniformity, high traffic density, complex interaction among individuals and the like. In an expressway traffic flow, driving strategies such as constant-speed driving, vehicle-following driving and abnormal driving dominated by overtaking are different for different drivers. The driving strategies of drivers in the expressway traffic flow are difficult to observe and vary randomly, resulting in a high degree of complexity and uncertainty exhibited in the expressway traffic flow. Therefore, the extraction of characteristic parameters of the expressway traffic flow is of great significance to simplifying and expressing complex geographic spatial-temporal processes such as the expressway traffic flow. Meanwhile, stochastic oscillation in the expressway traffic flow can reduce traffic capacity, so that accurate expression of the characteristics of the expressway traffic flow has become an important premise for traffic management, prevention and control.

The existing method for extracting and expressing traffic flow description characteristics, mainly based on a macroscopic analysis view angle, aims to extract characteristics and states of traffic flows by extracting time-varying characteristics and spatial characteristics of traffic flow parameters and analyzing traffic flow states. The existing traffic state parameters mainly comprise two types: (1) traffic flow, speed, and traffic flow density; and (2) proportion of large cars, average speed difference between large cars and small cars and traffic saturation. The traffic flow characteristic parameter expression method mainly comprises a parameter relation model and a clustering method, which are specifically as follows:

(1) Parameter relation model: three basic parameters of speed, flow and density are selected to establish a three-parameter relation model suitable for a specific traffic flow. According to different running mechanisms of the traffic flow, the traffic flow is divided into three states: a free-moving flow state, a steady flow state, and an unsteady flow state. In addition, traffic flow states are divided based on the concept of qualitative and quantitative combination from different scales and using a probability theory and a regressive analysis method.

(2) Clustering method: traffic state parameters are extracted based on a traffic volume time series obtained from the traffic management department, and then subjected to clustering analysis, and the characteristics of traffic flows of different scales are extracted with reference to the real running condition of the traffic flows.

Stochastic oscillation in the expressway traffic flow is mainly caused by dynamic adjustment of the driving strategy of the driver, which provides main characteristics and structures of the expressway traffic flow. The traditional method can only analyze the whole condition or state of the traffic flow from a macroscopic view, and lacks dynamic description of driving strategies of drivers in the traffic flow and sufficient description of microscopic characteristics of the traffic flow.

### SUMMARY

The technical problem to be solved herein is to provide a method for expressing characteristics of a traffic flow based on a quantum harmonic oscillator model, in which traffic flow characteristic parameters are visually expressed and the regularity and the difference of traffic flow state characteristics are analyzed on a spatial-temporal scale to deeply explore traffic flow characteristics.

To solve the technical problem above, the present invention provides a method for expressing characteristics of a traffic flow based on a quantum harmonic oscillator model, comprising:

(1) constructing an energy eigenequation of a quantum harmonic oscillator for vehicle movement and converting the energy eigenequation to an Hermite polynomial;

(2) solving traffic flow characteristic parameters using K-order Hermite polynomial approximation; and

(3) expressing the traffic flow characteristic parameters on a sphere.

Preferably, the constructing an energy eigenequation of a quantum harmonic oscillator for vehicle movement and converting the energy eigenequation to an Hermite polynomial in the step (1) is specifically as follows: in an expressway traffic flow, all vehicles run at a constant speed v, then an ideal position of any vehicle i at a time point t is clear and definite, and is recorded as Sᵢₜ; in a real expressway traffic flow, a driver may accelerate or decelerate according to comprehensive reasons such as driving environment and personal decision, such that the real speed is greater than or less than the speed v, which are recorded as |↑ [symbol] and |↓ [symbol] , and then the real position of the vehicle is ahead of or behind the ideal position Sᵢₜ, which are recorded as |→ [symbol] and |← [symbol] ; in a process of quantization description, a speed of the vehicle can be characterized as a superposition state Vₜ=aₜ|↑ [symbol] +bₜ|↓ [symbol] i, and a position of the vehicle can be characterized as a superposition state Sₜ=cₜ|→ [symbol] +dₜ|← [symbol] i, wherein i is an imaginary unit, at and bₜ represent probability amplitudes of acceleration and deceleration, respectively, cₜ and dₜ represent probability amplitudes of the vehicle position being ahead of or behind the ideal position, respectively, and |aₜ|²+|bₜ|²=|cₜ|²+|dₜ|²=1;

accordingly, the movement of the vehicle can be described as a quantum harmonic oscillator with an energy eigenequation as shown in equation (1):

$$iA \frac{d}{dt} ψ ( x ) = H ψ ( x ) \qquad ( 1 )$$

wherein i is an imaginary unit; A is a constant describing the distribution of individual energy levels; ψ(x) is a wave function representing the probability amplitude of an individual appearing at a specific position; H=ƒ(Vₜ)+g (Sₜ) is Hamiltonian of the system and a core characteristic of dynamic evolution of the system; ƒ(Vₜ) and g(Sₜ) are kinetic energy and potential energy of the harmonic oscillator, respectively. Equation (1) can be described as a second-order non-homogeneous linear differential equation in the form of

$$\frac{d {ψ ( x )}^{2}}{{dt}^{2}} + P ( x ) \frac{d ψ ( x )}{dt} + Q ( x ) ψ ( x ) = f ( x ) ,$$

and the general solution form shown in equation (2) can be obtained:

$$\frac{d {ψ ( x )}^{2}}{{dt}^{2}} + P ( x ) \frac{d ψ ( x )}{dt} + Q ( x ) ψ ( x ) = f ( x ) \\ {ψ}_{K} ( x ) = {\sum }_{n = 0}^{K} {C}_{n} ( x ) {e}^{\frac{- {x}^{2}}{2}} \qquad ( 2 )$$

equation (2) can be converted to an Hermite equation as follows:

$${ψ}_{K} ( x ) = {\sum }_{n = 0}^{K} \frac{{w}_{n}}{{( \sqrt{π} {2}^{n} n ! )}^{\frac{1}{2}}} {H}_{n} ( x ) {e}^{\frac{- {x}^{2}}{2}} \qquad ( 3 )$$

wherein K represents the number of energy levels characterizing the number of driving strategies which can be selected by the driver in the driving process, Hₙ(x) is an n-order Hermite polynomial, and wₙ is a fitting parameter of the wave function characterizing a probability amplitude of the harmonic oscillator at different energy levels.

Preferably, the solving the traffic flow characteristic parameters using K-order Hermite polynomial approximation in the step (2) is specifically as follows: in quantum mechanics, the probability can be expressed as square of the wave function, so that the probability of the vehicle appearing at a specific position in the expressway traffic flow can be expressed as equation (4):

$$P = {\vert {ψ}_{n} ( x ) \vert}^{2} = {( {\sum }_{0}^{n} \frac{{w}_{n}}{{( \sqrt{π} {2}^{n} n ! )}^{\frac{1}{2}}} {H}_{n} ( x ) {e}^{\frac{- {x}^{2}}{2}} )}^{2} \qquad ( 4 )$$

equation (4) is a QHO model of a long-distance expressway traffic flow;

considering that

$$\frac{{e}^{\frac{- {x}^{2}}{2}}}{\sqrt{2 π}}$$

is a probability density function of a standard normal distribution
function,

$${h}_{n} ( x ) = {H}_{n} ( x ) \frac{{e}^{\frac{- {x}^{2}}{2}}}{{( \sqrt{π} {2}^{n} n ! )}^{\frac{1}{2}}}$$

is converted to probability expression of the Hermite polynomial, wherein hₙ(x) reflects oscillation structures of different modes; ƒ(x) is set as a density function of vehicle probability distribution, then the K-order Hermite polynomial approximation conversion is an optimization problem as equation (5):

$$\{ \begin{matrix}Objective function : \hat{f} ( x ) = {( {\sum }_{0}^{K} {w}_{n} {h}_{n} ( x ) )}^{2} \\ Constraint : {\sum }_{0}^{K} {w}_{n}^{2} = 1\end{matrix} \qquad ( 5 )$$

equation (5) can be solved through constrained nonlinear optimization, and is solved using a method for mapping between a unit sphere and a unit plane since a constraint condition of the characteristic parameter is Σₙ₌₀^{K} wₙ²=1;

in the QHO model, the determination of the order K is directly relevant to the understanding of the traffic flow distribution characteristics, and thus an optimal order is selected as far as possible according to the characteristics and the state of the traffic flow; according to Occam's Razor, if not necessary, a second-order QHO model is usually constructed by selecting K=2, and three model parameters w₀, w₁, w₂ can be obtained through approximation conversion of a 2-order Hermite polynomial, wherein the three parameters, as traffic flow characteristic parameters in the model, are probability amplitudes of wave function distribution modes of a ground state, a first excited state and a second excited state, respectively.

Preferably, the expressing the traffic flow characteristic parameters on a sphere in the step (3) is specifically as follows: in a quantum harmonic oscillator model, for a superposition structure of corresponding wave functions for three different energy level states in the driving strategy of the traffic flow, three characteristic parameters w₀, w₁, w₂ are selected according to waveform analysis of the Hermite polynomial, wherein the three characteristic parameters are probability amplitudes of wave function distribution modes of a ground state, a first excited state and a second excited state, respectively, squares of the probability amplitudes are probabilities of the three states, respectively, and Σₙ₌₀^{K} wₙ²=1; in a practical situation, an absolute value of the w₀ is the largest, which means that the vehicle runs at a stable constant-speed driving state in the driving process for most of the time; a driving state of the traffic flow at a specific place and a specific time point can be accurately described by providing a set of model parameters; by introducing a three-dimensional spherical coordinate system with a central point of (0,0,0), the sum of squares of point coordinates on the sphere is always 1, namely x²+y²+z²=1; the traffic flow characteristic parameters (w₀, w₁, w₂) are mapped to the sphere, so that the relation among the parameters can be observed visually; the distribution among the spherical coordinates of the parameters can describe the clustering condition and the difference change of the traffic flow state visually, and reasons of changes of the traffic flow state are analyzed according to specific data.

Beneficial effects: On the premise of the autonomous decision of a driving strategy by a driver and centering on the objective limitation that the individual accurate state information in the long-distance expressway traffic flow is not observable, the dynamic evolution of the speed and the state of the vehicle is described using a quantum state, the driving state of the vehicle is expressed as the superposition state of three driving states, and the probability of the three states is represented using QHO model parameters; traffic flow characteristics are deeply explored by visually expressing the traffic flow characteristic parameters and analyzing the regularity and the difference of the traffic flow state characteristics on a spatial-temporal scale.

### BRIEF DESCRIPTION OF THE DRAWINGS

FIG. 1 is a schematic diagram of a procedure of the method according to the present invention.

FIG. 2 is a schematic diagram of modeling of an expressway traffic flow based on a quantum harmonic oscillator model according to the present invention.

FIG. 3 is a schematic diagram of a projection for the optimization solution according to the present invention.

FIG. 4 is a schematic diagram of an annual traffic flow characteristic parameter expression of the year 2015 for 225 stations in South Jiangsu.

FIG. 5 is schematic diagrams of traffic flow characteristic parameter expressions of January, April, July and October of the year 2015 at Changzhoubei station according to the present invention.

FIG. 6 is schematic diagrams of annual traffic flow characteristic parameter expression of the year 2015 at different time windows (2, 10, 30 and 60 minutes) at Changzhoubei station according to the present invention.

### DETAILED DESCRIPTION

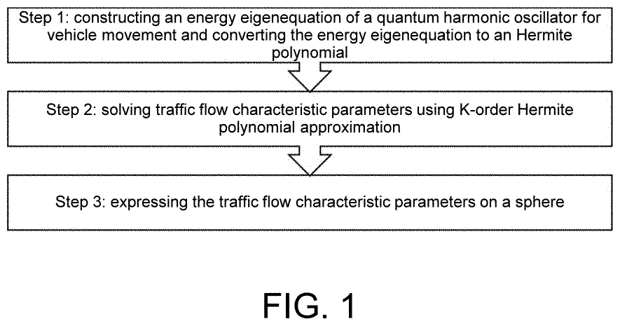

As shown in FIG. 1, provided is method for expressing characteristics of a traffic flow based on a quantum harmonic oscillator model, comprising:

(1) constructing an energy eigenequation of a quantum harmonic oscillator for vehicle movement and converting the energy eigenequation to an Hermite polynomial;

(2) solving characteristic parameters using K-order Hermite polynomial approximation; and

(3) expressing the traffic flow characteristic parameters on a sphere.

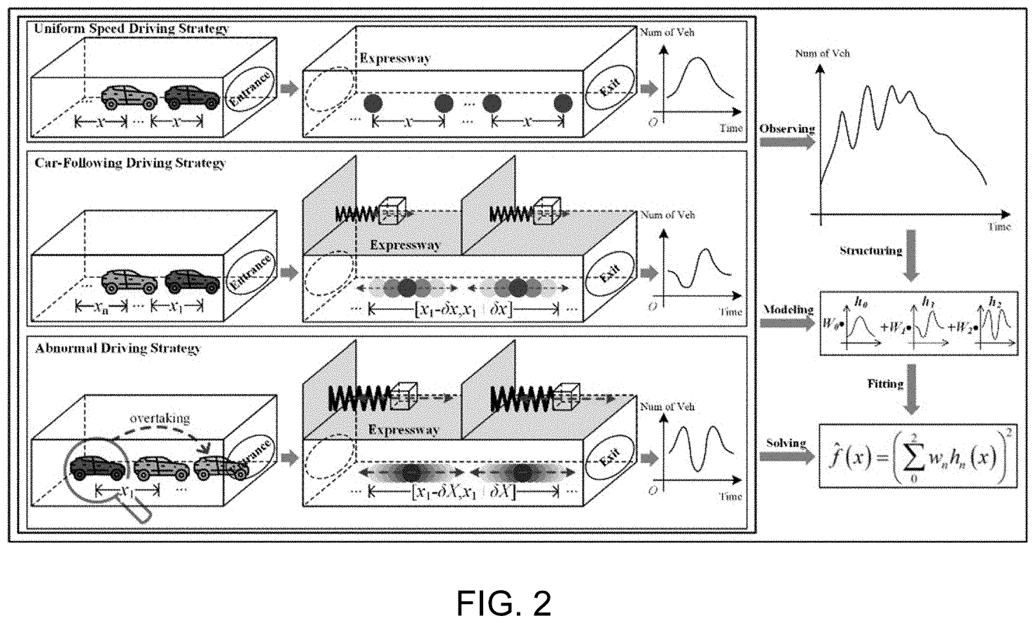

The driving of vehicles in the long-distance expressway traffic flows has high complexity and uncertainty. The driving strategies of the vehicle are assumed to mainly comprise three types, namely constant-speed driving, vehicle-following driving and abnormal driving (dominated by overtaking). In the process of constant-speed driving, vehicles enter a station in a certain distribution and run at a constant speed, the vehicles do not interact with each other in the whole expressway traffic process until the vehicles exit the station at the constant speed, and the traffic flow exits the expressway in a certain vehicle sequence distribution. This is the ground state of the whole traffic flow, so that the ground state can be used as the energy ground state of the quantum harmonic oscillator. In vehicle-following driving of the long-distance expressway traffic flow, dynamic change between the vehicle-following distance and the speed of front and rear vehicles is similar to an evolution law of two sliders connected by a virtual spring, and the acceleration/deceleration motion of the front vehicle can cause stretching/extrusion of the virtual spring, so that a virtual force can be generated to accelerate/decelerate the rear vehicle, and thus the front and rear vehicles return to the equilibrium state of a new speed after a period of time. In the long-distance expressway traffic flow, when the speed of a front vehicle is slow or the front vehicle is decelerated, some drivers may adopt an overtaking strategy, so that the original traffic flow sequence is interrupted and stochastic oscillation in the long-distance expressway traffic flow is formed, which can be considered as state transition in a quantum harmonic oscillator model. For a single vehicle in the long-distance expressway traffic flow, the driving strategy of the vehicle is adjusted over time, so that obvious stochastic oscillation is generated in the long-distance expressway traffic flow. In the process of quantization description, the definite position and the driving state of each vehicle cannot be accurately determined, the position is represented by the presence of the probability distribution described by a wave function near a specific position, and the driving strategy is represented by the distribution superposition structure of the corresponding wave functions in three different energy level states, namely constant-speed driving state, vehicle-following driving state and abnormal driving state. The schematic diagram of traffic flow characteristic expression modeling based on the QHO model is shown in FIG. 2. The traffic flow characteristic parameters (w₀, w₁, w₂) represent probability amplitudes of the three states, respectively, describe a waveform structure of a traffic flow wave function, and can accurately reflect the state change in the whole traffic flow. By using the characteristic parameters, the characteristics of the traffic state can be directly identified, and the differences and the similarities of expressway traffic flows at different regions, different times and different scales can also be identified and explained.

The constructing an energy eigenequation of a quantum harmonic oscillator for vehicle movement and converting the energy eigenequation to an Hermite polynomial in the step (1) is specifically as follows: in an long-distance expressway traffic flow, all vehicles run at a constant speed v, then an ideal position of any vehicle i at a time point t is clear and definite, and is recorded as Sᵢₜ; in a real expressway traffic flow, a driver may accelerate or decelerate according to comprehensive reasons such as driving environment and personal decision, such that the real speed is greater than or less than the speed v, which are recorded as |↑ [symbol] and |↓ [symbol] , and then the real position of the vehicle is ahead of or behind the ideal position Sᵢₜ, which are recorded as |→ [symbol] and |← [symbol] ; in a process of quantization description, a speed of the vehicle can be characterized as a superposition state Vₜ=aₜ|↑ [symbol] +bₜ|↓ [symbol] i, and a position of the vehicle can be characterized as a superposition state Sₜ=cₜ|→ [symbol] +dₜ|← [symbol] i, wherein i is an imaginary unit, at and bₜ represent probability amplitudes of acceleration and deceleration, respectively, cₜ and dₜ represent probability amplitudes of the vehicle position being ahead of or behind the ideal position, respectively, and |aₜ|²+|bₜ|²=|cₜ|²+|dₜ|²=1;

accordingly, the movement of the vehicle can be described as a quantum harmonic oscillator with an energy eigenequation as shown in equation (1):

$$iA \frac{d}{dt} ψ ( x ) = H ψ ( x ) \qquad ( 1 )$$

wherein i is an imaginary unit; A is a constant describing the distribution of individual energy levels; ψ(x) is a wave function representing the probability amplitude of an individual appearing at a specific position; H=ƒ(Vₜ)+g (Sₜ) is Hamiltonian of the system and a core characteristic of dynamic evolution of the system; ƒ(Vₜ) and g(Sₜ) are kinetic energy and potential energy of the harmonic oscillator, respectively. Equation (1) can be described as a second-order non-homogeneous linear differential equation in the form of

$$\frac{d {ψ ( x )}^{2}}{{dt}^{2}} + P ( x ) \frac{d ψ ( x )}{dt} + Q ( x ) ψ ( x ) = f ( x ) ,$$

and the general solution form shown in equation (2) can be obtained

$$\frac{d {ψ ( x )}^{2}}{{dt}^{2}} + P ( x ) \frac{d ψ ( x )}{dt} + Q ( x ) ψ ( x ) = f ( x ) \\ {ψ}_{K} ( x ) = {\sum }_{n = 0}^{K} {C}_{n} ( x ) {e}^{\frac{- {x}^{2}}{2}} \qquad ( 2 )$$

equation (2) can be converted to an Hermite equation as follows:

$${ψ}_{K} ( x ) = {\sum }_{n = 0}^{K} \frac{{w}_{n}}{{( \sqrt{π} {2}^{n} n ! )}^{\frac{1}{2}}} {H}_{n} ( x ) {e}^{\frac{- {x}^{2}}{2}} \qquad ( 3 )$$

wherein K represents the number of energy levels characterizing the number of driving strategies which can be selected by the driver in the driving process, Hₙ(x) is an n-order Hermite polynomial, and wₙ is a fitting parameter of the wave function characterizing a probability amplitude of the harmonic oscillator at different energy levels.

The solving parameters of the characteristics using K-order Hermite polynomial approximation in the step (2) is specifically as follows: in quantum mechanics, the probability can be expressed as square of the wave function, so that the probability of the vehicle appearing at a specific position in the long-distance expressway traffic flow can be expressed as equation (4):

$$P = {\vert {ψ}_{K} ( x ) \vert}^{2} = {( {\sum }_{n = 0}^{K} \frac{{w}_{n}}{{( \sqrt{π} {2}^{n} n ! )}^{\frac{1}{2}}} {H}_{n} ( x ) {e}^{\frac{- {x}^{2}}{2}} )}^{2} \qquad ( 4 )$$

equation (4) is a QHO model of a long-distance expressway traffic flow;

considering that

$$\frac{{e}^{\frac{- {x}^{2}}{2}}}{\sqrt{2 π}}$$

is a probability density function of a standard normal distribution function,

$${h}_{n} ( x ) = {H}_{n} ( x ) \frac{{e}^{\frac{- {x}^{2}}{2}}}{{( \sqrt{π} {2}^{n} n ! )}^{\frac{1}{2}}}$$

is converted to probability expression of the Hermite polynomial, wherein hₙ(x) reflects oscillation structures of different modes; ƒ(x) is set as a density function of vehicle probability distribution, then the K-order Hermite polynomial approximation conversion is an optimization problem as equation (5):

$$\{ \begin{matrix}Objective function : \hat{f} ( x ) = {( {\sum }_{n = 0}^{K} {w}_{n} {h}_{n} ( x ) )}^{2} \\ Constraint : {\sum }_{n = 0}^{K} {w}_{n}^{2} = 1\end{matrix} \qquad ( 5 )$$

wherein wₙ is a coefficient of n-order term of an Hermite polynomial to be fitted, characterizing a probability amplitude of probability distribution hₙ of the wave function at a position x;

equation (5) can be solved through constrained nonlinear optimization, and is solved using a method for mapping between a unit sphere and a unit plane since a constraint condition of the characteristic parameter is Σₙ₌₀^{K} wₙ²=1;

in the QHO model, the determination of the order K is directly relevant to the understanding of the traffic flow distribution characteristics, and thus an optimal order is selected as far as possible according to the characteristics and the state of the traffic flow; according to Occam's Razor, if not necessary, a second-order QHO model is usually constructed by selecting K=2, and three model parameters w₀, w₁, w₂ can be obtained through approximation conversion of a 2-order Hermite polynomial, wherein the three parameters, as traffic flow characteristic parameters in the model, are probability amplitudes of wave function distribution modes of a ground state, a first excited state and a second excited state, respectively.

Preferably, the expressing the traffic flow characteristic parameters on a sphere in the step (3) is specifically as follows: in a quantum harmonic oscillator model, for a superposition structure of corresponding wave functions for three different energy level states in the driving strategy of the traffic flow, three characteristic parameters w₀, w₁, w₂ are selected according to waveform analysis of the Hermite polynomial, wherein the three characteristic parameters are probability amplitudes of wave function distribution modes of a ground state, a first excited state and a second excited state, respectively, squares of the probability amplitudes are probabilities of the three states, respectively, and Σₙ₌₀^{K} wₙ²=1; in a practical situation, an absolute value of the w₀ is the largest, which means that the vehicle runs at a stable constant-speed driving state in the driving process for most of the time; a driving state of the traffic flow at a specific place and a specific time point can be accurately described by providing a set of model parameters; by introducing a three-dimensional spherical coordinate system with a central point of (0,0,0), the sum of squares of point coordinates on the sphere is always 1, namely x²+y²+z²=1; the traffic flow characteristic parameters (w₀, w₁, w₂) are mapped to the sphere, so that the relation among the parameters can be observed visually; the distribution among the spherical coordinates of the parameters can describe the clustering condition and the difference change of the traffic flow state visually, and reasons of changes of the traffic flow state are analyzed according to specific data.

According to the three driving strategies assumed above, a 2-order Hermite polynomial is selected for the fitting, and the L-BFGS is selected for the optimization, and the traffic volume time series of 225 expressway stations in South Jiangsu in 2015 are selected as experimental data.

The difference between the stations is mainly the change of their geographical positions, i.e., their distances from the entry station. In a long-distance expressway traffic flow, the driving strategy of the vehicle is changed according to its different driving distances. In addition, the spatial position is an important factor influencing the change of the characteristic parameters of the QHO model. Through the traffic flow characteristic parameter expression, the similarity and difference between different stations can be analyzed and described more intuitively, and thus the change of the traffic flow characteristics based on the spatial position can be further analyzed, thereby providing a data basis for describing the traffic flow characteristics.

Time scale is another important factor influencing the change of characteristic parameters of the QHO model. Season change is obvious in China, and the driving strategy adopted on the expressway changes over. Therefore, it is very necessary to express and analyze the traffic flow characteristic parameters in the time scale.

The time window is the data acquisition time frequency, that is, the number of vehicles passing through the station is counted in a certain time period. The time scale and the space scale influence the traffic flow characteristics from the perspective of the expressway traffic, and the size of the time window influences the size of the selected scale of the basic data of the traffic data, so the time window will also affect the QHO traffic characteristic parameters. In order to better express and describe the characteristics of traffic flow, the expression of traffic characteristic parameters under different time windows is explored.

In the present invention, the traffic volume time series of 225 expressway stations in South Jiangsu in 2015 are selected as experimental data, and the data acquisition time frequencies/time windows are 2, 10, 30 and 60 minutes.

The movement of the vehicle is described as a quantum harmonic oscillator, and finally, the expressway traffic flow is described as the following form:

$${ψ}_{K} ( x ) = {\sum }_{n = 0}^{K} {C}_{n} ( x ) {e}^{\frac{- {x}^{2}}{2}} \qquad ( 6 )$$

equation (6) can be converted to an Hermite equation as follows:

$${ψ}_{K} ( x ) = {\sum }_{n = 0}^{K} \frac{{w}_{n}}{{( \sqrt{π} {2}^{n} n ! )}^{\frac{1}{2}}} {H}_{n} ( x ) {e}^{\frac{- {x}^{2}}{2}} \qquad ( 7 )$$

wherein x represents a position of the vehicle in the expressway, i.e., a distance from the distance of entering the station, and ψ_{K}(x) is a wave function representing a probability amplitude of the vehicle appearing at a position x.

In quantum mechanics, the probability can be expressed as the square of a wave function, and thus the probability of a vehicle appearing at a specific position in a long-distance expressway traffic flow can be expressed as equation (8):

$$P = {\vert {ψ}_{K} ( x ) \vert}^{2} = {( {\sum }_{n = 0}^{K} \frac{{w}_{n}}{{( \sqrt{π} {2}^{n} n ! )}^{\frac{1}{2}}} {H}_{n} ( x ) {e}^{\frac{- {x}^{2}}{2}} )}^{2} \qquad ( 8 )$$

(w₀, w₁, w₂) is solved using a function approximation method by acquiring an observed probability P of a vehicle appearing at a particular spatial position.

In the QHO-based traffic flow characteristic expression method, the determination of the order K is directly relevant to the understanding of the traffic flow distribution characteristics, and thus an optimal order is selected according to the characteristics and the state of the traffic flow. From the waveform characteristics of the Hermite polynomial, the distribution structure of the ground state is described by a 0-order Hermite polynomial, and the waveform structure is a uniformly transmitted unimodal waveform similar to that each vehicle keeps continuous running at a relatively fixed speed under the condition of uniform oscillation near an equilibrium position. The distribution structure of the first excited state is described by 1-order Hermite polynomial, and its waveform structure is a superposed oscillation with positive and negative feedback, representing a tight vehicle-following process of alternate accelerating/decelerating of the vehicle near an equilibrium position. The higher-level excited state can be characterized by a high-order Hermite polynomial, represents a higher-frequency multimodal fluctuation, shows stronger vehicle interactions, and reflect fierce driving, overtaking and other abnormal driving behaviors in traffic flow. Finally, a second-order QHO model is constructed by selecting K=2 according to Occam's Razor.

ƒ(x) is set as the probability density function of the vehicle distribution, then the 2-order Hermite polynomial approximation conversion is the optimization problem as in equation (9):

$$\{ \begin{matrix}Objective function : \hat{f} ( x ) = {( {\sum }_{n = 0}^{2} {w}_{n} {h}_{n} ( x ) )}^{2} \\ Constraint : {\sum }_{n = 0}^{2} {w}_{n}^{2} = 1\end{matrix} \qquad ( 9 )$$

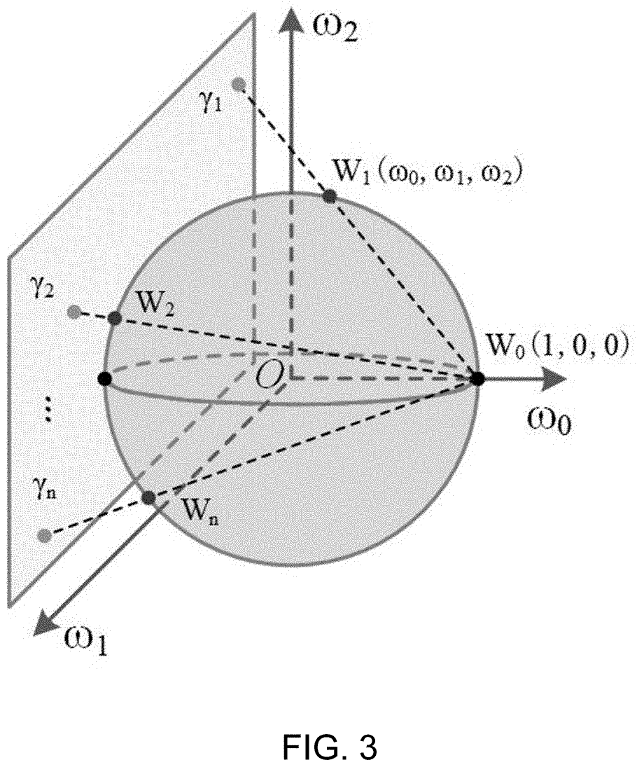

Equation (9) can be solved by constrained nonlinear optimization. However, the constraint is Σₙ₌₀^{K} wₙ²=1, that is, the feasible solutions of wₙ are distributed on the unit sphere, making it difficult to search along a monotonic gradient. To reduce the complexity of the solution, points on an N-dimensional sphere [symbol] ^{N} can be projected onto a plane [symbol] ^{N+1} by inverse stereographic projection, so that an unconstrained optimization solution can be performed on the plane, as shown in FIG. 3. To this end, with W₀(1,0,0) as the origin, the feasible solutions on the unit sphere are projected onto the plane x=−1, that is, W₁ is projected as y₁, and Wₙ is projected as yₙ, so that the dimension-reducing transformation of the feasible region is realized, and the optimization solution of Wₙ on the unit sphere is converted to the optimization solution of yₙ on the two-dimensional plane. After the optimal solution of yₙ is obtained, the dimension-increasing transformation is performed to realize the optimization solution of wₙ.

Based on the optimization solution, the configuration of the optimal driving state approximating the traffic flow oscillation structure can be obtained. Finally, characteristic parameters of different times, different stations and different time windows are obtained, wherein the results of 6 stations are shown in Table 1. The three characteristic parameters w₀, w₁, w₂ are probability amplitudes of wave function distribution modes of a ground state, a first excited state and a second excited state, respectively.

TABLE 1
Solutions of characteristic parameters of six stations from
Nanjing-Wuxi section of Shanghai-Nanjing Expressway

| | Tangshan | Jurong | Heyang | Xuejia | Changzhoubei | Wuxibei |
|---|---|---|---|---|---|---|
| Station | station | station | station | station | station | station |
| w0 | 0.957122 | 0.952827 | 0.948248 | 0.931228 | 0.929279 | 0.935641 |
| w1 | −0.0548 | −0.064 | −0.0412 | −0.01797 | −0.03973 | −0.03895 |
| w2 | 0.284455 | 0.296691 | 0.314847 | 0.363995 | 0.367234 | 0.350797 |

Based on the property that the sum of squares of the traffic flow characteristic parameters is 1, the calculated traffic flow characteristic parameters can be drawn on the unit sphere, such that the visual expression of abstract parameters is realized. Meanwhile, based on different analysis purposes, the present patent application divides the spherical expression of characteristic parameters into three types: space-based spherical characteristic expression, time-based spherical characteristic expression and time window-based spherical characteristic expression.

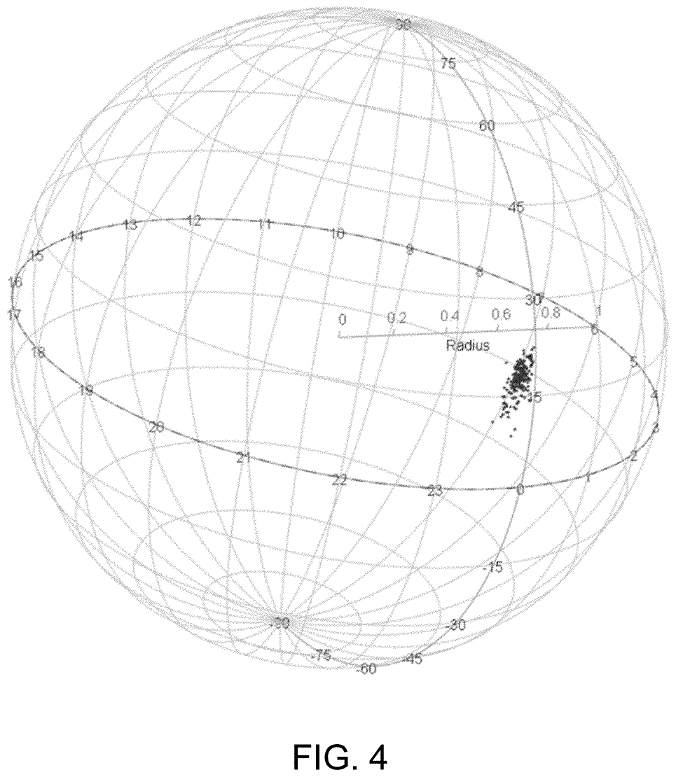

To explore the change rule of traffic flows of different stations, the traffic flow characteristic parameters are solved by using the traffic volume time series of 225 stations in South Jiangsu (the time window is 10 minutes) in 2015, and the result is visualized on a unit sphere to form a traffic flow characteristic expression on the spatial scale, as shown in FIG. 4.

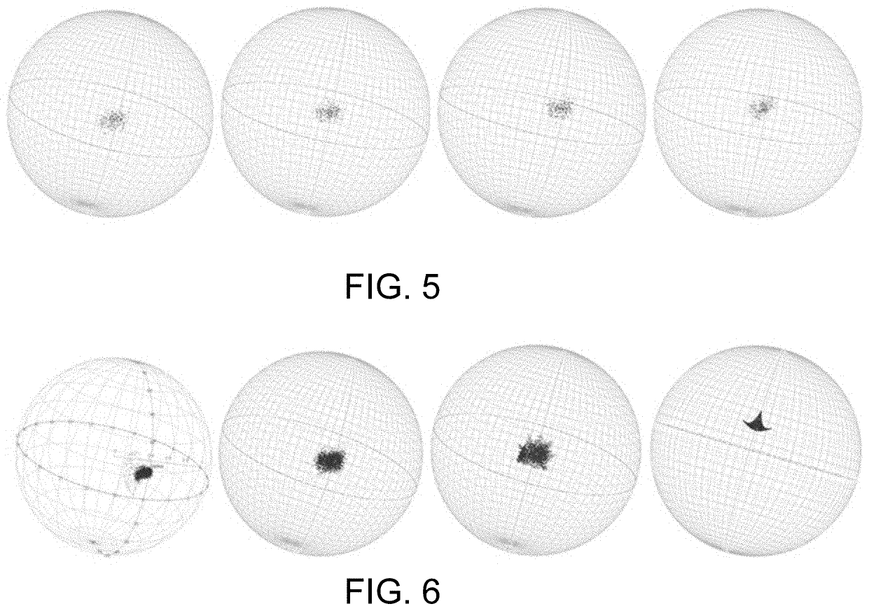

To explore the change rule of traffic flows on the time scale, taking the traffic volume time series of January, April, July and October of Changzhoubei station (the time window is 10 minutes) in 2015 as an example, and based on the principle of calculating a group of characteristic parameters (namely about 180 characteristic parameters per month) every four hours, the characteristic parameters of the traffic flow for the four months are obtained, and the result is visualized on a unit sphere to form a traffic flow characteristic expression on the time scale, as shown in FIG. 5.

To explore the change rule of traffic flows under different time windows, taking the traffic volume time series of Changzhoubei station in 2015 as an example, and based on the principle of calculating a group of characteristic parameters every four hours, the characteristic parameters in four time windows (2, 10, 30 and 60 minutes) are calculated, and the result is visualized on a unit sphere to form traffic flow characteristic expressions under different time windows, as shown in FIG. 6. Specially, with the time window gradually widened, the aggregation degree of characteristic parameters increased significantly, and even the characteristic parameters show a regular distribution shape under the time window of 60 minutes.

1. A method for expressing traffic flow characteristics based on a quantum harmonic oscillator model, comprising:
(1) constructing an energy eigenequation of a quantum harmonic oscillator for vehicle movement and converting the energy eigenequation to an Hermite polynomial;
(2) solving traffic flow characteristic parameters using K-order Hermite polynomial approximation; and
(3) expressing the traffic flow characteristic parameters on a sphere.

2. The method according to claim 1, wherein the constructing the energy eigenequation of the quantum harmonic oscillator for the vehicle movement and converting the energy eigenequation to the Hermite polynomial in the step (1) is specifically as follows: in an expressway traffic flow, all vehicles run at a constant speed v, then an ideal position of any vehicle i at a time point t is clear and definite, and is recorded as Sᵢₜ; in a real expressway traffic flow, a driver may accelerate or decelerate according to comprehensive reasons such as driving environment and personal decision, such that a real speed is greater than or less than the speed v, which are recorded as |↑ [symbol] and |↓ [symbol] , and then a real position of the vehicle is ahead of or behind the ideal position Sᵢₜ, which are recorded as |→ [symbol] and |← [symbol] ; in a process of quantization description, a speed of the vehicle can be characterized as a superposition state Vₜ=aₜ|↑ [symbol] +bₜ|↓ [symbol] i, and a position of the vehicle can be characterized as a superposition state Sₜ=cₜ|→ [symbol] +dₜ|← [symbol] i, wherein i is an imaginary unit, aₜ and bₜ represent probability amplitudes of acceleration and deceleration, respectively, cₜ and dₜ represent probability amplitudes of the vehicle position being ahead of or behind the ideal position, respectively, and |aₜ|²+|bₜ|²=|cₜ|²+|dₜ|²=1;
accordingly, the movement of the vehicle can be described as a quantum harmonic oscillator with an energy eigenequation as shown in equation (1):
$$i A \frac{d}{dt} ψ ( x ) = H ψ ( x ) \qquad ( 1 )$$
wherein i is an imaginary unit; A is a constant describing the distribution of individual energy levels; ψ(x) is a wave function characterizing a probability amplitude of the individual appearing at a specific position; ƒ(Vₜ) and g(Sₜ) are kinetic energy and potential energy of the harmonic oscillator, respectively; H=f (Vₜ)+g(Sₜ) is Hamiltonian of a system and a core characteristic of dynamic evolution of the system; equation (1) can be described as a second-order non-homogeneous linear differential equation in the form of
$$\frac{d {ψ ( x )}^{2}}{{dt}^{2}} + P ( x ) \frac{d ψ ( x )}{dt} + Q ( x ) ψ ( x ) = f ( x ) ,$$
and the general solution form shown in equation (2) can be obtained:
$$\frac{d {ψ ( x )}^{2}}{{dt}^{2}} + P ( x ) \frac{d ψ ( x )}{dt} + Q ( x ) ψ ( x ) = f ( x ) \qquad ( 2 )$$
$${ψ}_{K} ( x ) = {\sum }_{n = 0}^{K} {C}_{n} ( x ) {e}^{\frac{- {x}^{2}}{2}}$$
equation (2) can be converted to an Hermite equation as follows:
$${ψ}_{K} ( x ) = {\sum }_{n = 0}^{K} \frac{{w}_{n}}{{( \sqrt{π} {2}^{n} n ! )}^{\frac{1}{2}}} {H}_{n} ( x ) {e}^{\frac{- {x}^{2}}{2}} \qquad ( 3 )$$
wherein K represents a number of energy levels characterizing a number of driving strategies which can be selected by the driver in the driving process, Hₙ(x) is an n-order Hermite polynomial, and wₙ is a fitting parameter of the wave function characterizing a probability amplitude of the harmonic oscillator at different energy levels.

3. The method according to claim 1, wherein solving the traffic flow characteristic parameters using the K-order Hermite polynomial approximation in the step (2) is specifically as follows: in quantum mechanics, a probability can be expressed as square of the wave function, so that a probability of the vehicle appearing at a specific position in the expressway traffic flow can be expressed as equation (4):
$$P = {\vert {ψ}_{K} ( x ) \vert}^{2} = {( {\sum }_{n = 0}^{K} \frac{{w}_{n}}{{( \sqrt{π} {2}^{n} n ! )}^{\frac{1}{2}}} {H}_{n} ( x ) {e}^{\frac{- {x}^{2}}{2}} )}^{2} \qquad ( 4 )$$
equation (4) is a QHO model of a long-distance expressway traffic flow;
considering that
$$\frac{{e}^{\frac{- {x}^{2}}{2}}}{\sqrt{2 π}}$$
is a probability density function of a standard normal distribution function,
$${h}_{n} ( x ) = {H}_{n} ( x ) \frac{{e}^{\frac{- {x}^{2}}{2}}}{{( \sqrt{π} {2}^{n} n ! )}^{\frac{1}{2}}}$$
is converted to probability expression of the Hermite polynomial, wherein hₙ(x) reflects oscillation structures of different modes; ƒ(x) is set as a density function of vehicle probability distribution, then the K-order Hermite polynomial approximation conversion is an optimization problem as equation (5):
$$\{ \begin{matrix}Objective function : \hat{f} ( x ) = {( {\sum }_{n = 0}^{K} {w}_{n} {h}_{n} ( x ) )}^{2} \\ Constraint : {\sum }_{n = 0}^{K} {w}_{n}^{2} = 1\end{matrix} \qquad ( 5 )$$
equation (5) can be solved through constrained nonlinear optimization, and is solved using a method for mapping between a unit sphere and a unit plane since a constraint condition of the characteristic parameter is Σₙ₌₀^{K}wₙ²=1;
in the QHO model, the determination of the order K is directly relevant to the understanding of the traffic flow distribution characteristics, and thus an optimal order is selected as far as possible according to the characteristics and the state of the traffic flow; according to Occam's Razor, if not necessary, a second-order QHO model is usually constructed by selecting K=2, and three model parameters w₀, w₁, w₂ can be obtained through approximation conversion of a 2-order Hermite polynomial, wherein the three parameters, as traffic flow characteristic parameters in the model, are probability amplitudes of wave function distribution modes of a ground state, a first excited state and a second excited state, respectively.

4. The method according to claim 1, wherein the expressing the traffic flow characteristic parameters on the sphere in the step (3) is specifically as follows: in a quantum harmonic oscillator model, for a superposition structure of corresponding wave functions for three different energy level states in the driving strategy of the traffic flow, three characteristic parameters w₀, w₁, w₂ are selected according to waveform analysis of the Hermite polynomial, wherein the three characteristic parameters are probability amplitudes of wave function distribution modes of a ground state, a first excited state and a second excited state, respectively, squares of the probability amplitudes are probabilities of the three states, respectively, and Σₙ₌₀² wₙ²=1; in a practical situation, an absolute value of the w₀ is the largest, which means that the vehicle runs at a stable constant-speed driving state in the driving process for most of the time; a driving state of the traffic flow at a specific place and a specific time point can be accurately described by providing a set of model parameters; by introducing a three-dimensional spherical coordinate system with a central point of (0,0,0), the sum of squares of point coordinates on the sphere is always 1, namely x²+y²+z²=1; the traffic flow characteristic parameters (w₀, w₁, w₂) are mapped to the sphere, so that the relation among the parameters can be observed visually; the distribution among the spherical coordinates of the parameters can describe the clustering condition and the difference change of the traffic flow state visually, and reasons of changes of the traffic flow state are analyzed according to specific data.
